(19) United States
(12) Patent Application Publication
(10) Pub. No.: US 2002/0194079 A1
(43) Pub. Date: Dec. 19, 2002

(54) Method for monitoring and restricting online purchases

(75) Inventor: Christopher John kimble, Pine Island, MN (US)

Correspondence Address: Gero G. McClellan, Thomason Moser & Patterson, L.L.P., 3040 Post Oak Boulevard, Suite 1500, Houston, TX, 77056-6582, US

(73) Assignee: International Business Machines Corporation, Armonk, NY

(21) Appl. No.: 09/884,379

(22) Filed: Jun. 19, 2001

(51) Int. Cl. G06F 17/60

(52) U.S. Cl. 705/26

(57) ABSTRACT

A method for prohibiting predetermined categories of online purchases, the method including the steps of generating a database of user specific preferences, generating a categorized database of web sites offering online purchases, and receiving an online purchase request from a user. The method further includes determining if the online purchase request corresponds to an entry in the categorized database of web sites offering online purchases, and prohibiting the online purchase request if a corresponding entry is found in the categorized database of web sites offering online purchases and if the user specific preferences indicate that that the online purchase request corresponds to a type of purchases to be prohibited. The method may generally be implemented through an Internet service provider, through a credit card authorization process, or through additional software configured to cooperatively operate with a user's browser program at the personal computer level.

### BACKGROUND OF THE INVENTION

1. Field of the Invention

The present invention generally relates to a method for monitoring and restricting purchases made through an online medium.

2. Description of the Related Art

The development and advancement of the World Wide Web and/or Internet, hereinafter collectively referred to as the Internet, has spawned an entire new sector for conducting commerce, which is generally referred to as e-commerce. The vast availability and ease of access to the Internet in commercialized nations has for the most past encouraged electronic commerce through substantially reducing the time required to conduct transactions. For example, prior to the development of e-commerce, a transaction generally included mailing product descriptions to potential purchasers, receiving orders from purchasers through either mail or a telephonic center, processing the order and then shipping the customer's order to the customer location. Thus, the process of purchasing products regularly involved several days and/or weeks to complete. However, the introduction of e-commerce afforded manufacturers and/or sellers of goods and services the ability to electronically combine the advertising/product presentation processes with the order processing/shipping process. Therefore, through e-commerce, manufacturers and/or sellers of goods and services may present/advertise products to users through an Internet web page, for example, and receive electronically transmitted orders from customers viewing the web page through, for example, electronic mail services and/or dedicated frame-type order forms presented directly on the manufacturer's web site. The end result of the implementation of e-commerce methods and processes is generally that products and services may be electronically presented and instantly available for shipping to potential customers via an electronic medium at any time. Further, orders may be electronically received from customers in a fraction of a second, which may reduce the conventional transaction time of several days or weeks down to a few seconds, exclusive of delivery of the product or service.

However, the advancement of e-commerce also presents several disadvantages. For example, instances of purchase related credit card fraud have substantially increased through the development of e-commerce processes, as electronic transactions generally do not require verification that a purchaser is in fact the holder of a card being used for the transaction. As such, a cardholder's credit card number may be obtained by a potential wrongdoer from an old receipt, for example, and then used to purchase goods/services electronically.

Another disadvantage of the development of e-commerce methods and processes is the ease of availability of certain generally addictive/compulsive web sites, i.e., online gambling and pornographic pay-to-view-type sites that are often abused by compulsive gamblers and underage persons. For example, online gambling sites generally allow an online gambler to use a credit card to make charges to obtain chips or credits to conduct online gambling activities. Credit card charges are generally made electronically through the gambling web site and gambling funds instantly made available to the user. Therefore, if an online gambler obtains a cardholder's credit card number, the card number may be used to conduct online gambling activity well before the cardholder will typically become aware of the charges to the card. A similar situation may occur with respect to online pornographic pay-to-view-type sites, as a viewer of these types of sites may obtain an cardholder's credit card number and charge a membership to a pornographic site to the cardholder and utilize the site well in advance of the cardholder receiving a statement indicating that the card has been used for pornographic activity.

Therefore, although the development of e-commerce has provided an advantageous and efficient new avenue for conducting commerce, these benefits come with several distinct disadvantages. More particularly, e-commerce presents substantial obstacles to credit card companies and credit card holders, as e-commerce renders these parties vulnerable to unauthorized charges that may easily be made through e-commerce processes and methods. One particular situation where the ability to monitor and/or restrict credit card purchases online may be beneficial is at the individual personal computer level. For example, individual computer users may desire to restrict online purchases from their respective personal computers. This feature, for example, may prevent underage family members, friends, coworkers, or other parties that may have access to a particular personal computer from using the computer to make online purchases with specific credit cards. This embodiment may also be applied to a particular Internet service provider account in similar fashion to the application to a single personal computer. Another situation may be where a cardholder desires to restrict credit card purchases from various online merchants despite the physical location of the buyer. In this situation, the ability to monitor and prevent various e-commerce charges may reside within the credit card company's computer itself.

Therefore, there exists a need for a method for monitoring and/or restricting e-commerce related credit card purchases. More particularly, there is a need for a method for monitoring credit card purchases made from a specific personal computer, or alternatively, purchases made through a particular Internet service provider account or on a specific credit card.

### SUMMARY OF THE INVENTION

Embodiments of the invention generally provide a method for prohibiting predetermined categories of online purchases, wherein the method may include the steps of generating a database of user specific preferences, generating a categorized database of web sites offering online purchases, and receiving an online purchase request from a user. The method further includes determining if the online purchase request corresponds to an entry in the categorized database of web sites offering online purchases, and prohibiting the online purchase request if a corresponding entry is found in the categorized database of web sites offering online purchases and if the user specific preferences indicate that that the online purchase request corresponds to a type of purchases to be prohibited. The method may generally be implemented through an Internet service provider, through a credit card authorization process, or through additional software configured to cooperatively operate with a user's browser program at the personal computer level.

Embodiments of the invention further provide a method for prohibiting selected online purchases, wherein the method may include receiving an online purchase request and indexing into a categorized database of online web sites with a parameter representative of a web site intended to receive the online purchase request to determine if the web site intended to receive the online purchase request is a type of web site from which a user desires to prohibit purchases. Thereafter, the method may operate to block the online purchase request from being processed if the web site intended to receive the online purchase request is a type of web site from which the user desires to prohibit purchases.

### BRIEF DESCRIPTION OF THE DRAWINGS

So that the manner in which the above recited features, advantages, and objects of the invention are obtained may be understood in detail, a more particular description of the invention briefly summarized above may be had by reference to the embodiments thereof, which are illustrated in the appended drawings. It is to be noted, however, that the appended drawings illustrate only exemplary embodiments of the invention, and are therefore, not to be considered limiting of its scope, as the invention may admit to alternative equally effective embodiments that are not expressly illustrated in the drawings.

FIG. 1 illustrates an exemplary embodiment of an Internet service provider (ISP) based method for monitoring and restricting online purchases.

FIG. 2 illustrates an exemplary embodiment of a method for monitoring and restricting online purchases based within a credit card company's computer.

FIG. 3 illustrates an exemplary embodiment of a browser/plug-in based method for monitoring and restricting online purchases.

### DETAILED DESCRIPTION OF THE PREFERRED EMBODIMENT

Embodiments of the invention generally provide a credit-card proxy service that operates to shield customers from either unknowingly or uncontrollably purchasing products and/or services over the Internet and/or World Wide Web, both of which will hereinafter be collectively referred to as the “Internet.” Goods and services that are unknowingly purchased generally refers to situations where a person that is not authorized to utilize a cardholder's credit card makes a purchase without the cardholder's knowledge or permission. Examples of unknowingly purchased goods and services may be when an unknown third party unlawfully acquires a cardholder's credit card information, when a known party, such as a child or relative, for example, acquires a relative's credit card information and uses the information without the cardholder's permission, or other situations where the cardholder does not have any knowledge of the specific purchase. Uncontrollably purchased goods and/or services may generally refer to compulsion-type purchasing. Examples of compulsion type purchases may be online gambling purchases, online pornography purchases, and/or other purchases known to be addictive and/or facilitate compulsive purchasing behavior.

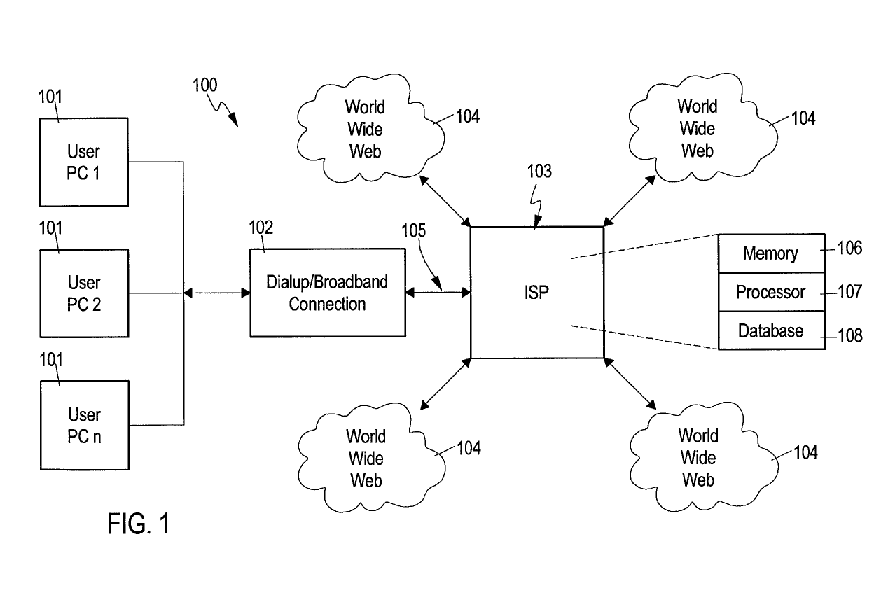

FIG. 1 illustrates an exemplary embodiment of an ISP based method for monitoring and restricting online purchases. In the exemplary embodiment of FIG. 1, a system for monitoring and restricting purchases 100 includes at least one user personal computer 101. Each of the personal computers (PCs) 101 are generally in communication with communications medium 102, such as a telephone line or a broadband communications medium, for example, that allows the respective PCs 101 to communicate with an ISP 103. The communications links between the respective user PCs and the ISP 103 are typically bi-directional-type communications links that allow for PCs 101 to communicate data to the ISP, as well as allowing the ISP to communicate data to the respective PCs 101, which is commonly known as uploading and downloading from the user PC perspective. The ISP 103 is typically in communication with a plurality of other computers, servers, networks, and/or other computer/database related devices 104 that are commonly known to form the World Wide Web. Therefore, in a typical operational scheme, if a user desires to access information on a remote Internet web site, then the user may access the desired web site through one of PCs 101 that is configured to communicate with ISP 103. In this configuration the user may access information on any one of computer devices 104 that comprise the web.

However, in the present embodiment of the invention, ISP 103 is further configured to monitor information sent from each of the user PCs 101 for attempted online purchases. Once an online purchase is determined from the ISP's monitoring process, the ISP may further be configured to determine if the online purchase is a type of purchase that the user/account holder has determined to be prohibited. If ISP determines that the attempted purchase is one that the user/account holder desires to be prohibited, then the ISP may block the purchase from occurring through the ISP 103.

In order for ISP 103 to effectively monitor and prohibit selected online purchases, ISP 103 may generally have access to information representative of the types of purchases that a particular user/account holder desires to prohibit, the user/account holder's credit cardholder information, a dynamically maintained and categorized data base of Internet web sites that users/account holders are likely to prohibit purchases from, and/or any other information that may be useful in determining if an online purchase is a type of purchase that a user/account holder does not authorize. Therefore, as illustrated in FIG. 1, ISP 103 may further include a memory 106, a processor 107, and a database 108. Memory 106, for example, may be used to store information relative to the ISP 103 users/account holder's preferences. These preferences may be, for example, the types of Internet purchases that the specific user's/account holders desire to prohibit, i.e. gambling, pornography, shopping, etc., and/or credit card information for the ISP's users/account holders. Database 108, which may be stored locally on the ISP 103, or alternatively, remotely accessed by ISP 103 through the Internet or other communications link, may, for example, contain a categorized list of web sites that offer purchases that are likely to be prohibited by the ISP's users. For example, database 108 may contain a categorized listing of gambling web sites, pornography web sites, online shopping web sites, and/or any other category/type of web site that the ISPs users may desire to prohibit purchases from. Processor 107 may generally be configured to support the operations required to determine if an attempted online purchase is a type of purchase that the user/account holder has determined to be prohibited and block those attempted purchases that are determined to be prohibited.

Database 108, which will generally be substantial in size, may be created and maintained through, for example, a web crawler-type operation. Generally, a web crawler operation/program is configured to continually access Internet web sites and search for particular attributes that indicate that the particular web site is a type of site that users/account holders may desire to prohibit purchases from. For example, a web crawler may be configured to access web sites and search for particular related terms, such as, for example, wager or betting. If the crawler operation determines that a particular web site has one of the designated terms within the web site, then the web site may be added to database 108 as a site that gambling-type purchases are prohibited from. Further, when the site is added to database 108, the site may be categorized as a particular type of site, i.e., a gambling site, so that the determined site may be associated with other sites determined to be gambling related. This categorization allows for the respective categories of sites to be efficiently searched when ISP 103 is attempting to determine if a site whereon a user/account holder is attempting to make a purchase qualifies as a category of site that the user has prohibited purchases from.

As an example, database 108 may contain a plurality of categorized lists, wherein each of the individual lists represents a category/type of web site offering online purchases. For example, one category/type of list may be a listing of known Internet web sites offering gambling related goods and services for sale. The individual lists within database 108 may continually be updated through the web crawler operation. Additionally, the web crawler operation may further be configured to implement an oversight process, wherein various web sites located by the crawler operation are verified by an operator.

In operation, the embodiment illustrated in FIG. 1 generally begins with the user providing credit card information to the ISP. This information, which may correspond to specific credit cards that the user desires to block from being used for specific types of online purchases, may be stored by the ISP 103 in memory 106. Alternatively, the user's credit card information may be stored on the user's local machine or at another remote location that the ISP 103 has access to. The user will also provide the ISP 103 with information pertaining to the types of purchases that are to be prohibited by the present invention. For example, the user may indicate to the ISP 103 that the user desires to prohibit all gambling related purchases through the user's ISP account. This information may also be stored in memory 106, or alternatively, in a remote database that ISP 103 has access to. Additionally, the user may also specify a specific time period during which specific types of purchases are to be prohibited, wherein the types of purchases cannot be modified or changed during the specified time period. This feature allows users of the invention, and in particular users desiring to prevent compulsive behavior, from modifying the types of prohibited purchases during the specific time frame, which prevents a compulsive user from simply changing the prohibited purchases every time compulsive behavior exists.

Once the ISP 103 has acquired the necessary user information, then the ISP 103 is generally ready to begin monitoring the user's ISP account for purchase related information. In this process the ISP 103 may utilize various known monitoring processes. For example, ISP 103 may use a data masking technique to search through each data string submitted by the user to the ISP. The mask technique may be configured to search for the user's credit card information being transmitted to a web site, which would indicate that the user's ISP account is being used to make an online purchase. Further, the method of the present exemplary embodiment may incorporate encryption techniques in order to monitor traffic for the user's credit card information, as this type of financial information is generally transmitted over the Internet using some sort of encryption process. If the ISP 103 determines that the user's credit card information is being transmitted to a web site, then the ISP 103 may then intervene and determine if the information is being transmitted to a web site that offers goods and services on the user's list of prohibited types of goods and services/online purchases. In order to make this determination, the ISP 103 may cross reference the web site address, or other relevant identifying information, with the categorized information contained within database 108. If an entry in database 108 matches the web site address where the purchase is being attempted, then the ISP 103 may prohibit and/or block the purchase, as the purchase is being attempted on a web site that has been determined to offer goods and services that the user desires to prohibit. Alternatively, if the web site address is not in the database, then the method of the invention may be configured to either allow the purchase, block the purchase pending classification of the web site, provisionally allow the purchase, or another process desired by the user.

For example, if the user has previously set up pornographic web sites as a type of web site where purchases are to be prohibited thorough the user's ISP account, then when the user's credit card information is transmitted to the ISP 103 in an attempted purchase, the ISP will first determine if the receiving web site is a type of site from which the user desires to prohibit purchases, i.e., a pornographic web site. This determination may be made by cross-referencing the receiving web site address or other identifying information into a list of known pornographic web sites stored within database 108. If the ISP 103 determines that the receiving web site has been identified as a web site offering pornographic material for sale online, then the user's purchase may be blocked by ISP 103.

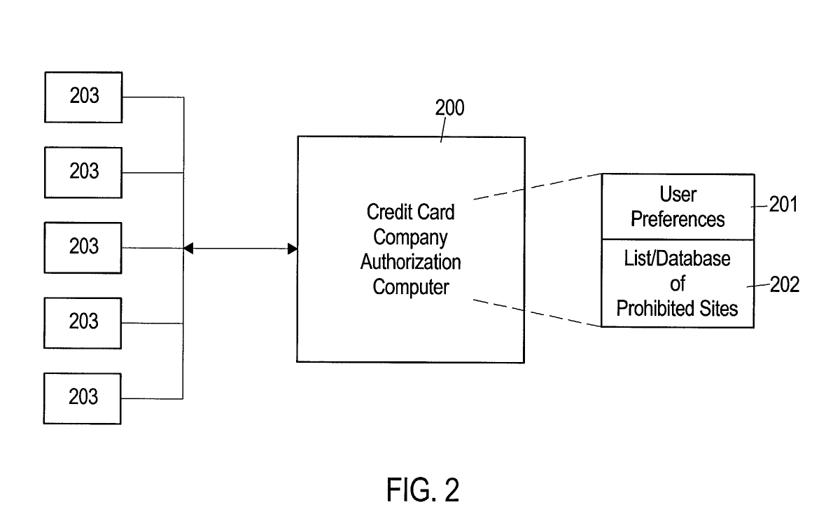

In another embodiment of the invention the method for blocking unauthorized online purchases may be implemented directly by credit card companies. In this embodiment customers may utilize any ISP, as the credit card company's authorization processes and/or hardware may generally execute the blocking features of the present invention. An exemplary embodiment of the present invention implemented on a credit card company's authorization system is illustrated in FIG. 2. The exemplary credit card authorization embodiment utilizes the credit card company's automated charge authorization process to support the method of the present invention. The charge authorization process is generally conducted via a central charge authorization computer system 200 that is selectively in communication with a plurality of merchants 203. For example, when a merchant 203 receives a credit card for payment, the merchant 203 will generally swipe/read the credit card in an authorization machine. The authorization machine generally operates to transmit the user's credit card information to the credit card company's charge authorization computer system/network via a telephone line, for example. The credit card company's authorization system then checks the card information against a plurality of parameters to determine if the charge is to be authorized. If the charge is determined to be authorized by the credit card company's authorization system 200, then system 200 will generally send an approval number back to the merchant 203 that authorizes the purchase.

The present exemplary embodiment may modify the credit card company's approval process to include the method of the present invention. In particular, the credit card authorization computer may be configured to conduct an additional charge authorization step in order to implement the method of the present exemplary embodiment. The additional authorization step may include determining if the charge submitted for purchase is an online charge, or alternatively, another type of charge that does not require the cardholder to appear in person. Thereafter, if the charge is determined to be an online-type charge, then the credit card authorization computer 200 may index into user profile information 201 to determine what specific types of online purchases the cardholder may have prohibited, if any. This profile information, for example, may be similar to the profile information contained within memory 106 of the embodiment illustrated in FIG. 1, and may be provided to the credit card company's authorization computer by the user through an input process. If the user has set up specific types of online purchases to be prohibited, then the credit card authorization computer 200 may then index into a list/database of online merchants that may be blocked with the user's profile information 201 to determine if the attempted purchase is a type of purchase that the user profile prohibits. Database 202, for example, may contain potential prohibited merchant information similar to the database 108 of the embodiment illustrated in FIG. 1, and may again be generated and maintained by a web-crawler type operation. If the credit card authorization computer 200 determines that the charge is to a type of merchant that the user/cardholder desires to prohibit, then the authorization computer 200 may refuse the charge and not issue a charge authorization number to merchant 203. Therefore, in this embodiment, the monitoring of purchases and the determination of what purchases are prohibited is generally conducted by the credit card company's authorization computers. As such, users of the present invention are not required to use a particular ISP in order to monitor and prohibit selected types of purchases.

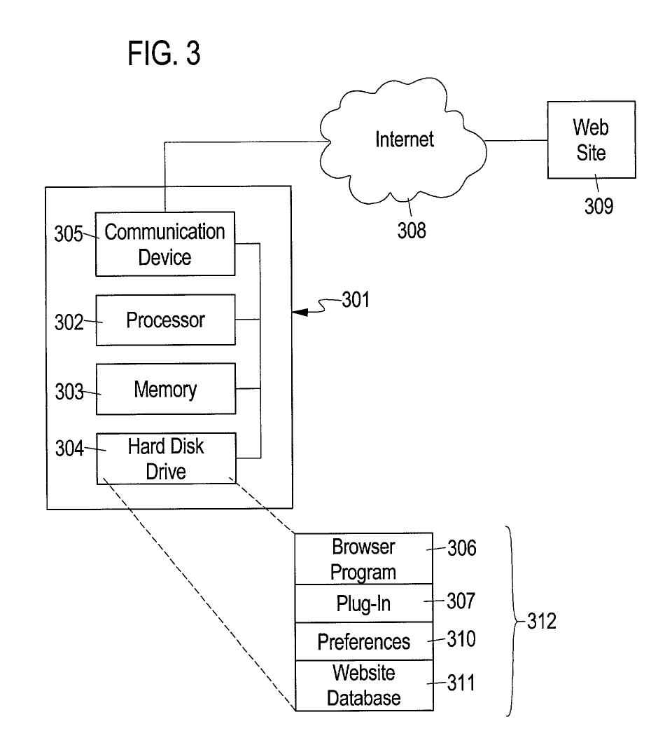

In another embodiment of the invention, the method for monitoring and prohibiting selected types of online purchases may be implemented at the user level. In this embodiment, which is illustrated in FIG. 3, the user's computer (PC) 301 may locally operate to execute the method/process of the present exemplary method. The user PC may, for example contain a processor 302, a volatile-type memory 303, and non-volatile-type memory 304, and a communications device 305. The processor 302 may be configured to execute programs stored on memory 304, which may be a hard disk drive (HDD). The programs may be run by processor 302 in conjunction with memory 303, which may be a RAM-type memory, as is known in the art. The communications device 305, which may be a modem or other broadband communications device, for example, may interface with the processor to allow the PC 301 to access the Internet 308.

In operation, the present embodiment invention may be implemented through software processes, which may be supported by software programs/data 312 stored on the HDD 304. Programs/data 312 may include an Internet browser program 306, such as Microsoft's® Internet Explorer® or Netscape's® Navigator®, for example, that may be used to access the Internet via the communications device 305. Therefore, when a user is browsing/surfing the Internet and attempts to make a purchase through an online merchant web site 309, the user will generally input credit card information into an input field of the browser program so that the information may be transmitted to the merchant web site 309. The browser program 306, however, may be operating in conjunction with a separate program 307, which may be hidden from general viewing, that is configured to initiate a method for monitoring and prohibiting selected credit card purchases on PC 301. Program 307, which may be a plug-in type software, may be configured to trap a credit card number input into browser program 306 to make an online purchase, determine the types of online purchases that the user desires to prohibit from user preferences 310, and index a web site into database 311 to determine if the merchant web site 309 is a site that is prohibited by the user. Preferences 310, which may be similar to the information contained within either memory 106 of FIG. 1 or user preferences 201 of FIG. 2, generally include information entered by the user of the method of the present invention, wherein the information generally corresponds to the types of purchases to be prohibited and the credit card numbers/information that are to be monitored. Database 311, which may be similar to database 108 in the exemplary embodiment illustrated in FIG. 1 or list/database 202 in the exemplary embodiment illustrated in FIG. 2, generally contains categorized information representing web sites upon which purchases may be prohibited. In similar fashion to the embodiment illustrated in FIG. 1, the database of the present embodiment may be dynamically updated and maintained by a web-crawler, such as, for example, Google®. Therefore, in the present exemplary embodiment, if the web site 309 is listed in database 311, then PC 301, acting under the instruction of plug-in 307, may prohibit the attempted purchase as being a type of purchase that the user desires to prohibit.

In another embodiment of the invention, the database 311 may be maintained remotely. For example, database 311 may be removed from the user's local PC 301, the ISP 103, or the credit card company's computer 200 and located on a remote web site, for example. Therefore, in this embodiment, which may be implemented into any of the previously discussed embodiments, the process of indexing into the database of sites where purchases are prohibited generally involves accessing the remote database in order to determine if a merchant is on a prohibited list. This access step may generally be accomplished through a typical Internet browse or link operation, for example. Similarly, the user preferences may also be removed from the respective local machines and located remotely on a web site, for example. Thus, the user preference may be remotely accessed through an Internet browse or link operation.

Additionally, in each of the embodiments of the present invention it is contemplated that the user, i.e., the cardholder, will be the only person allowed to modify the user preferences. This function may be accomplished through a password protection process so that third parties may not simply change the user's preferences to allow purchases that are intended to be prohibited by the user. This feature generally prevents unauthorized users, i.e., children or other unauthorized parties, from changing the user preferences to allow prohibited purchases.

While the foregoing is directed to embodiments of the present invention, other and further embodiments of the invention may be devised without departing from the basic scope thereof, and the scope thereof is determined by the claims that follow.

1. A method for prohibiting predetermined categories of online purchases, comprising:
generating a database of user specific preferences;
generating a categorized database of web sites offering online purchases;
receiving an online purchase request from a user;
determining if the online purchase request corresponds to an entry in the categorized database of web sites offering online purchases; and
prohibiting the online purchase request if a corresponding entry is found in the categorized database of web sites offering online purchases and if the user specific preferences indicate that that the online purchase request corresponds to a type of purchase to be prohibited.

2. The method of claim 1, wherein generating a database of user specific preferences further comprises receiving user information corresponding to user credit card information and types of purchases that the user desires to prohibit.

3. The method of claim 1, wherein generating a categorized database of web sites offering online purchases further comprises executing a web crawler operation configured to search through Internet web sites, identify commerce related sites, and store a categorized list of the commerce related sites in a memory device.

4. The method of claim 1, wherein determining if the online purchase request corresponds to an entry in the categorized database of web sites offering online purchases further comprises indexing into the categorized database with a parameter representative of the web site receiving the online purchase request to determine if a matching parameter resides in the categorized database of web sites.

5. The method of claim 1, wherein prohibiting the online purchase request further comprises blocking a user's credit card information from being transmitted to the web site offering online purchases.

6. The method of claim 1, wherein receiving an online purchase request further comprises intercepting the online purchase request in an Internet service provider.

7. The method of claim 1, wherein receiving an online purchase request further comprises intercepting the online purchase request in a credit card company's credit card authorization system.

8. The method of claim 1, wherein receiving an online purchase request further comprises intercepting the online purchase request with a locally executed software process configured to monitor Internet traffic on a local system for purchase related information.

9. A method for prohibiting selected online purchases, comprising:
receiving an online purchase request;
indexing into a categorized database of online web sites with a parameter representative of a web site intended to receive the online purchase request to determine if the web site intended to receive the online purchase request is a type of web site from which a user desires to prohibit purchases from; and
blocking the online purchase request from being processed if the web site intended to receive the online purchase request is a type of web site from which the user desires to prohibit purchases from.

10. The method of claim 9, further comprising storing user information representative of the types of purchases the user desires to prohibit in an electronically accessible database.

11. The method of claim 9, further comprising generating the categorized database of online web sites through execution of a web crawler operation configured to identify and categorize web sites offering at least one of goods and services for sale thereon.

12. The method of claim 9, wherein indexing into the categorized database further comprises indexing into the categorized database with a web site address of the site intended to receive the online purchase request.

13. The method of claim 9, wherein the categorized database of online web sites further comprises a dynamically generated and maintained database of web sites offering online purchases, the database being categorized according to the type of online purchases offered by the individual web sites.

14. The method of claim 9, wherein blocking the online purchase request further comprises blocking the user's credit card information from being transmitted to the web site intended to receive the online purchase.

15. The method of claim 9, wherein receiving an online purchase request further comprises intercepting the online purchase request during a period when the online purchase request is being transmitted through an Internet service provider.

16. The method of claim 9, wherein receiving an online purchase request further comprises intercepting the online purchase request in a credit card authorization computer during a charge authorization process.

17. The method of claim 9, wherein receiving an online purchase request further comprises intercepting the online purchase request with a software process configured to cooperative operate with a browser program on the user's personal computer.

18. A method for blocking predetermined categories of online purchases, comprising:
receiving an online purchase request from a user, the online purchase request being associated with a parameter representative of an online merchant receiving the online purchase request;
determining if the online merchant offers categories of purchases that the user desires to prohibit by searching a categorized database of known online merchants with the parameter representative of the online merchant; and
blocking the completion of the online purchase request if the online merchant is determined to offer categories of purchases that the user desires to prohibit.

19. The method of claim 18, further comprising dynamically generating and maintaining the categorized database of known online merchants through a web crawler operation.

20. The method of claim 18, wherein receiving the online purchase request further comprises intercepting the online purchase request in at least one of an ISP based system, a credit card authorization based system, and a plug in-type software system.
